(19) United States
(12) Patent Application Publication
(10) Pub. No.: US 2024/0037305 A1
(43) Pub. Date: Feb. 1, 2024

(54) Virtual Platforms of Integrated Circuit Designs

(71) Applicant: Intel Corporation, Santa Clara, CA (US)

(72) Inventors: Kalen Brunham, Toronto (CA); Jakob Engblom, Kista AB (SE)

(21) Appl. No.: 18/481,935

(22) Filed: Oct. 5, 2023

(51) Int. Cl. G06F 30/3308; G06F 30/327

(52) U.S. Cl. CPC G06F 30/3308; G06F 30/327; G06F 2111/20

(57) ABSTRACT

Systems or methods of the present disclosure may provide receiving configuration data corresponding to a circuit design for programmable logic circuitry. A first intellectual property (IP) block is configured using parameterization data of the configuration data. A stub model is generated for a second IP block using interconnect and register data of the configuration data. A chip-level model is generated that represents the circuit design based on the first IP block, the stub model, and memory map data of the configuration data. The chip-level model is consumable by a virtual platform simulator.

### BACKGROUND

The present disclosure generally relates to integrated circuits, and, more particularly, to virtual platforms of integrated circuit designs.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

A development cycle for implementing integrated circuit designs may include a software development portion, a hardware development portion, and an integration testing portion. Overlap may exist between the software development and hardware development portions of the development cycle. Changes to the integrated circuit design during the development cycle may delay the software development portion, the hardware development portion, or both. Delaying the software development portion or the hardware development portion may extend the development cycle by delaying completion of the integration testing portion.

### BRIEF DESCRIPTION OF THE DRAWINGS

Various aspects of this disclosure may be better understood upon reading the following detailed description and upon reference to the drawings in which:

FIG. 1 is a block diagram of a system used to program an integrated circuit device and generate a virtual platform of the integrated circuit device, in accordance with an embodiment of the present disclosure;

FIG. 2 is a simplified block diagram of the virtual platform of FIG. 1, in accordance with an embodiment of the present disclosure;

FIG. 3 is a register map for a 32-bit interval timer of the integrated circuit device of FIG. 1, in accordance with an embodiment of the present disclosure;

FIG. 4 is a register map for a 64-bit interval timer of the integrated circuit device of FIG. 1, in accordance with an embodiment of the present disclosure;

FIG. 5 is a diagram that illustrates conformance between a hierarchy of a chip-level model and a hierarchy of a register-transfer level (RTL) logic or model characterizing a circuit design for a programmable logic device, in accordance with an embodiment of the present disclosure;

FIG. 6 is a flow diagram of a process of generating virtual platform models of integrated circuit designs, in accordance with an embodiment of the present disclosure; and

FIG. 7 is a block diagram of a data processing system including the integrated circuit device of FIG. 1, in accordance with an embodiment of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time-consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As discussed above, a development cycle of an integrated circuit design may be extended by delaying either a software development portion of the development cycle or a hardware development portion of the development cycle. Virtual platforms may be used to reduce extensions of the development cycle involving design changes to a software portion of the integrated circuit design. A virtual platform generally refers to a model or virtual representation of target hardware (e.g., a hardware portion of the integrated circuit design) that may be consumed by a simulator program (e.g., INTEL® SIMICS® by INTEL CORPORATION of Santa Clara, California, and the open-source simulator program, QEMU).

A virtual platform that models a hardware portion of the integrated circuit design may enable the software development portion of the development cycle to proceed before physical implementations of the hardware portion become available. An initial design state or a design state of the hardware portion when the software development portion commences may be used to generate the virtual platform. The virtual platform may run within an execution environment provided by a simulator program to execute the same software binaries (e.g., application software) that are executable by the hardware portion of the integrated circuit. The virtual platform may generate signals that simulate internal signals (e.g., register content) of the hardware portion of the integrated circuit for observation, fault injection, hardware/software integration testing, software debugging, and/or other software development related purposes. Design changes involving the hardware portion of the integrated circuit design may render the simulated internal signals insufficient for software development purposes.

The present disclosure describes systems and techniques related to generating a virtual platform for an integrated circuit design using configuration data corresponding to a hardware portion of the integrated circuit design. Design changes involving the hardware portion of the integrated circuit design may be implemented via the configuration data. By generating the virtual platform using the configuration data, the virtual platform may be dynamically updated to incorporate the design changes.

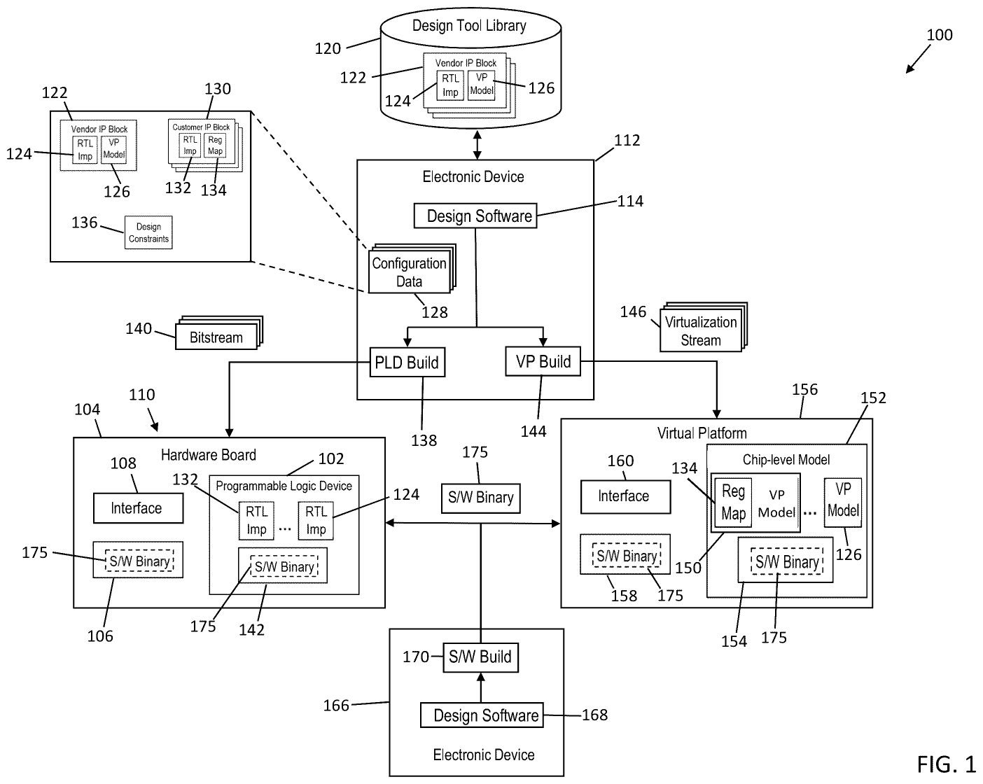

With the foregoing in mind, FIG. 1 is a block diagram of a system 100 that may be used to program or configure a programmable logic device (PLD) 102, in accordance with an embodiment of the present disclosure. The programmable logic device 102 may be reconfigurable (e.g., a field-programmable gate array (FPGA)) or may be application specific (e.g. a structured application specific integrated circuit (SASIC)). The programmable logic device 102 may include hard logic elements or hard intellectual property (IP) such as a hard processor system that are not programmable by end users. Functionality and/or connections of hard logic elements of the programmable logic device 102 are generally fixed when semiconductor fabrication operations are completed. While not generally programmable, some functionality and/or connections of hard logic elements of the programmable logic device 102 may be configurable or reconfigurable after semiconductor fabrication operations have been completed such as by using vendor-provided IP blocks. The programmable logic device 102 may also include programmable logic and programmable routing fabric that may be collectively referred to as soft logic elements of the programmable logic device 102. Functionality and/or connections of soft logic elements of the programmable logic device 102 are generally programmable by users or designers to implement custom functionality and custom connections after semiconductor fabrication operations have been completed.

The programmable logic device 102 may be coupled to a hardware board 104 (e.g., a printed circuit board) that may include various board-level components, such as a memory device 106 and interface circuitry 108. The memory device 106 may include a volatile memory device (e.g., a double data rate (DDR) memory device, static random-access memory (SRAM) and/or another volatile memory device) and/or a non-volatile memory device (e.g., a secure digital (SD) memory device and/or another non-volatile memory device). The interface circuitry 108 may be configured to communicatively couple the programmable logic device 102 with various board-level components such as the memory device 106. The interface circuitry 108 may also be configured to communicatively couple the programmable logic device 102 and/or the hardware board 104 with external interface circuitry associated with another hardware board, another programmable device, and/or an external computing system. The programmable logic device 102 and the hardware board 104 may form an integrated circuit system 110 (e.g., an embedded system). In an embodiment, the integrated circuit system 110 may include one or more of additional hardware boards and/or one or more additional programmable logic devices.

A user (e.g., a customer or designer) may interact with an electronic device 112 (e.g., a computer) to implement a hardware portion of a circuit design to be programmed onto the programmable logic device 102 using design software 114, such as a version of INTEL® QUARTUS® by INTEL CORPORATION of Santa Clara, California. A design tool library 120 communicatively coupled to the electronic device 112 may include a number of vendor IP blocks 122. The design tool library 120 may be operated by a vendor or a manufacturer of the programmable logic device 102. Each vendor IP block 122 may include register-transfer level (RTL) logic 124 or other low-level hardware description language logic for programming or configuring the programmable logic device 102 to implement functionality of the corresponding vendor IP block 122. Each vendor IP block 122 may also include a model 126 or virtual representation of the vendor IP block 122 that may be consumable by a simulator program (e.g., INTEL® SIMICS® by INTEL CORPORATION of Santa Clara, California, and the open-source simulator program, QEMU).

The design software 114 may generate configuration data 128 corresponding to the hardware portion of the circuit design to be programmed onto the programmable logic device 102. The configuration data 128 may include one or more vendor IP blocks 122 from the design tool library 120. The configuration data 128 may also include one or more customer IP blocks 130 generated by the user using the design software 114. A customer IP block 130 may represent an IP block that is unavailable in the design tool library 120. A customer IP block 130 may include register-transfer level (RTL) logic 132 or another low-level hardware description language logic for programming or configuring the programmable logic device 102 to implement respective functionality of the customer IP block 132. A customer IP block 130 may also include interconnect and register data 134 for configuring a register map of the customer IP block 130 and the programmable routing fabric of the programmable logic device 102 with respect to the customer IP block 130.

The configuration data 128 may also include one or more design constraints 136, such as parameterization data, memory map data, and/or external connectivity data. The parameterization data of the design constraints 136 may include a value set by the user for each configuration option of the corresponding vendor IP block 122. The memory map data of the design constraints 136 may configure a system-level memory map for the circuit design to be programmed onto the programmable logic device 102. The memory map data of the design constraints 136 may also define an association between a register map of each IP block (e.g., each vendor IP block 122 and/or each customer IP block 132) and the system-level memory map. The external connectivity data of the design constraints 136 may include information for integrating the programmable logic device 102 with board-level components, such as a memory size of the memory device 106 and input/output (I/O) pin assignments of the interface circuitry 108.

A PLD builder 138 (e.g., a compiler) may receive the configuration data 128 corresponding to the hardware portion of the circuit design from the design software 114. The PLD builder 138 may generate a bitstream 140 (e.g., machine-readable instructions representative of the hardware portion of the circuit design) based on the configuration data 128. The bitstream 140 may be loaded into programmable elements (e.g., fuses, anti-fuses, electrically programmable read-only-memory technology, random-access memory cells, mask-programmed elements, and/or configuration random-access memory (CRAM)) of the programmable logic device 102 via the interface circuitry 108 to cause the integrated circuit system 110 to implement functionalities of the hardware portion of the circuit design. For example, the RTL logic 124 of the bitstream 140 may cause the soft logic elements of the programmable logic device 102 to implement functionality of the corresponding vendor IP block 122. As another example, the RTL logic 132 of the bitstream 140 may cause the soft logic elements of the programmable logic device 102 to implement functionality of the corresponding customer IP block 130. As another example, the bitstream 140 may cause the soft logic elements of the programmable logic device 102 to provide a software-visible interface 142 for executing one or more software binaries. Software binaries executable by the software-visible interface 142 may include bootloaders, operating systems, low-level firmware, middleware, libraries, software development kits (SDKs), application programming interfaces (APIs), application software, and other software binaries.

A virtual platform (VP) builder 144 (e.g., a compiler) may also receive the configuration data 128 corresponding to the circuit design from the design software 114. In an embodiment, a computer-aided design (CAD) tool may include the design software 114, the PLD builder 138, and the VP builder 144. The VP builder 144 may generate a virtualization stream 146 (e.g., device language model (DML) or Python instructions defining a simulation object for each component of the circuit design) based on the configuration data 128. The virtualization stream 146 generated by the VP builder 144 may include a model or virtual representation for each component of the circuit design to be programmed onto the programmable logic device 102. Each model or virtual representation included in the virtualization stream 146 may be consumable by a simulator program (e.g., INTEL® SIMICS® by INTEL CORPORATION of Santa Clara, California, and the open-source simulator program, QEMU).

For example, the virtualization stream 146 may include the model 126 or virtual representation of the vendor IP block 122. The VP builder 144 may configure the model 126 to implement functionality of the corresponding vendor IP block 122 using parameterization data included in the design constraints 136 of the configuration data 128. The virtualization stream 146 may also include a stub model 150 or virtual representation of the corresponding customer IP block 130. The VP builder 144 may generate the stub model 150 using the interconnect and register data 134 of the corresponding customer IP block 130 from the configuration data 128.

The virtualization stream 146 may also include a chip-level model 152 that represents the circuit design implemented by the programmable logic device 102. The VP builder 144 may generate the chip-level-model 152 based on the model 126 that represents the corresponding vendor IP block 122, the stub model 150 that represents the corresponding customer IP block 130, and memory map data included in the design constraints 136 of the configuration data 128. The chip-level-model 152 may include a model 154 or virtual representation of the software-visible interface 142. The model 154 may be configured to execute software binaries that are executable by the software-visible interface 142. For example, software binaries executable by the model 154 may include bootloaders, operating systems, low-level firmware, middleware, libraries, SDKs, APIs, application software, and other software binaries executable by the software-visible interface 142.

The virtualization stream 146 may also include a platform-level model or virtual platform 156 that represents the integrated circuit system 110 formed by the hardware board 104 and the circuit design implemented by the programmable logic device 102. The VP builder 144 may generate the virtual platform 156 based on the chip-level-model 152 and external connectivity data included in the design constraints 136 of the configuration data 128. The virtual platform 156 may include models or virtual representations of various board-level components of the hardware board 104. For example, the virtual platform 156 may include a model 158 or virtual representation of the memory device 106. As another example, the virtual platform 156 may include a model 160 or virtual representation of the interface circuitry 108.

A user (e.g., a customer or designer) may interact with an electronic device 166 (e.g., a computer) to generate a software portion (e.g., a reference software stack) of a circuit design to be programmed onto the programmable logic device 102 using design software 168. The design software 168 may interact with a software builder 170 (e.g., a compiler) to generate software binaries 175 corresponding to the software portion of the circuit design. For example, the software binaries 175 may include bootloaders, operating systems, low-level firmware, middleware, libraries, SDKs, APIs, application software, and other software binaries corresponding to the software portion of the circuit design. The software binaries 175 generated by the software builder 170 may be executed by various components (e.g., the memory device 106 and/or the software-visible interface 142 provided by the soft logic elements of the programmable logic device 102) of the integrated circuit system 110. The software binaries 175 generated by the software builder 170 may also be executed by components (e.g., the model 154 of the software-visible interface 142 and/or the model 158 of the memory device 106) of the virtual platform 156 that represents the integrated circuit system 110.

FIG. 1 shows that the design software 114, the PLD builder 138, and the VP builder 144 may generate multiple iterations of the configuration data 128, the bitstream 140, and the virtualization stream 146, respectively. Each successive iteration may represent a design change to the hardware portion of the circuit design to be programmed onto the programmable logic device 102. This illustrates that the integrated circuit system 110 and the virtual platform 156 may both be updated to incorporate the design changes. By doing so, various components of the integrated circuit system 110 and the virtual platform 156 may continue to execute the software binaries 175 generated by the software builder 170 unencumbered the design changes.

In an embodiment, the VP builder 144 may generate the virtualization stream 146 that does not include a model or virtual representation of at least one component of the circuit design to be programmed onto the programmable logic device 102. For example, the VP builder 144 may generate the virtualization stream 146 that does not include a model 126 or virtual representation of a vendor IP block 122. As another example, the VP builder 144 may generate the virtualization stream 146 that does not include a stub model 150 or virtual representation of a customer IP block 130.

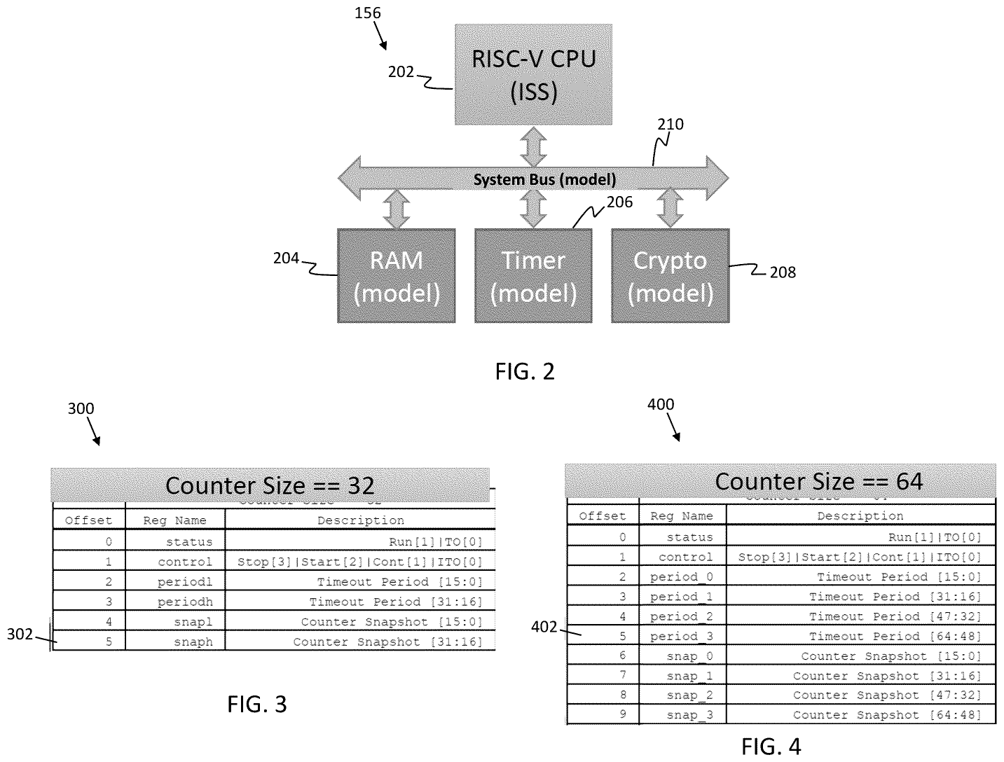

FIG. 2 is a simplified block diagram of the virtual platform 156 of FIG. 1, in accordance with an embodiment of the present disclosure. The virtual platform 156 may include at least one instruction set simulator (ISS) 202 to simulate or emulate a processor core of the target hardware such as a RISC-V processor. The virtual platform 156 may also include one or more models to simulate or emulate other components or sub-components of the target hardware. In FIG. 2, the virtual platform 156 includes a memory model 204, a timer model 206, and a cryptographic model 208 to simulate or emulate memory circuitry (e.g., RAM), timer circuitry (e.g., an interval timer), and cryptographic circuitry of the target hardware. In an embodiment, the one or more models of the virtual platform 156 may include a loosely-timed, transaction-level modeling (LT-TLM) model to simulate or emulate a peripheral component of the target hardware. In an embodiment, the one or more models of the virtual platform 156 may include an LT-TLM model to simulate or emulate a board-level component. For example, the board-level component may be a memory device and/or interface circuitry. Example memory devices may include a volatile memory device (e.g., a double data rate (DDR) memory device, static random-access memory (SRAM) and/or another volatile memory device) and/or a non-volatile memory device (e.g., a secure digital (SD) memory device and/or another non-volatile memory device). Example interface circuitry may include inter-integrated circuit (I2C), improved inter-integrated circuit (I3C), Ethernet, universal serial bus (USB), and/or other interface circuitry. The virtual platform 156 may also include infrastructure such as a system bus model 210 to couple the at least one ISS 202 with the one or models (e.g., the memory model 204, the timer model 206, and/or the cryptographic model 208). Infrastructure (e.g., the system bus model 210) of the virtual platform 156 may facilitate debugging of software binaries or code executing on the at least one ISS 202.

A virtual platform such as the virtual platform 156 may generally refer to a model or virtual representation of target hardware (e.g., the hardware board 104) that may be consumed by a simulator program (e.g., INTEL® SIMICS® by INTEL CORPORATION of Santa Clara, California, and the open-source simulator program, QEMU). A virtual platform may run within an execution environment provided by a simulator program to execute the same software binaries that are executable by target hardware being modeled by the virtual platform. Software binaries that are executable by a virtual platform may include bootloaders, operating systems, low-level firmware, middleware, libraries, software development kits (SDKs), application programming interfaces (APIs), application software, and other software binaries that are executable by target hardware being modeled by the virtual platform. By executing the same software binaries, a virtual platform may provide access to internal signals of target hardware, such as register content and/or other signals within the target hardware being simulated by the virtual platform. A virtual platform may enable software development to proceed before physical implementations of target hardware become available. For example, a virtual platform may provide access to internal signals of target hardware for observation, fault injection, hardware/software integration testing, software debugging, and/or other software development related purposes. In an embodiment, executing a software binary (e.g., the software binaries 175) on a virtual platform (e.g., the virtual platform 156) that is also executable by target hardware (e.g., the hardware board 104) may enable the software binary to be tested for both positive behavior and negative behavior. For example, if functionality of the virtual platform mirrors or substantially conforms with functionality of the target hardware, testing performed on the software binary executing on the virtual platform may enable a determination that if the software binary does not function properly on the virtual platform then the software binary will not function properly on the target hardware and vice versa. In an embodiment, a simulator program may run on a processor type that is different than a processor type of target hardware being modeled by a virtual platform.

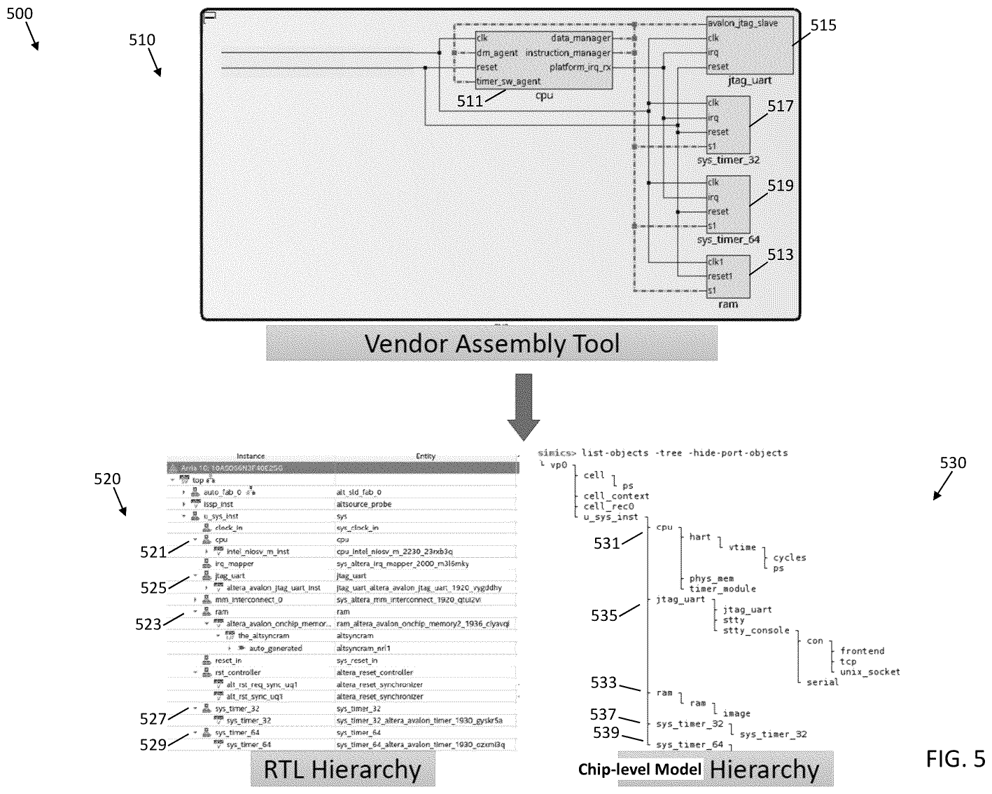

FIGS. 3-4 are diagrams that illustrate different register maps for an interval timer IP block. The PLD builder 138 may generate RTL logic based on the interval timer IP block for programming or configuring the programmable logic device 102 to implement an interval timer. The interval timer IP block may be a vendor IP block 122 obtained from the design tool library 120 or a customer IP block 132. The interval timer IP block may have a number of configurations options such as a counter size configuration option. A value of the counter size configuration option may be set via a user interface (e.g., a graphical user interface (UI)) of the design software 114. For example, the value of the counter size configuration option may be set to a 32-bit counter size to cause the PLD builder 138 to generate RTL logic for programming or configuring the programmable logic device 102 to implement a 32-bit interval timer.

Changing configuration options of an IP block may affect functionality of hardware. For example, the counter size configuration option of the interval timer IP block may be changed from the 32-bit counter size to a 64-bit counter size for various reasons such as a design change. Changing the counter size configuration option from the 32-bit counter size to the 64-bit counter size may affect functionality of the programmable logic device 102 by causing the PLD builder 138 to generate RTL logic for programming or configuring the programmable logic device 102 to implement a 64-bit interval timer.

Changing configuration options of an IP block may also affect register maps and other software visible aspects of hardware. For example, FIG. 3 illustrates a register map 300 for the interval timer IP block with the counter size configuration option set to the 32-bit counter size and FIG. 4 illustrates a register map 400 for the interval timer IP block with the counter size configuration option set to the 64-bit counter size. The register map 300 of FIG. 3 may include an offset address 302 with an offset value of 5 that references a register for storing counter snapshot values. The register map 400 of FIG. 4 may include an offset address 402 with an offset value of 5 that references a register for storing timeout period values.

A comparison between the register map 300 of FIG. 3 and the register map 400 of FIG. 4 shows that changing configuration options for a given IP block may modify a parameterization space of that IP block. In some instances, changing configuration options for one IP block may also modify a parameterization space of another IP block when those IP blocks implement related functionalities. A direct relationship may exist between complexity of an IP block and parameter space modifications caused by configuration option changes. For example, increasing complexity of an IP block may increase parameter space modifications caused by configuration option changes and decreasing complexity of an IP block may decrease parameter space modifications caused by

FIG. 5 is a diagram 500 that illustrates conformance between a hierarchy of a chip-level model and a hierarchy of RTL logic or model characterizing a circuit design for a programmable logic device, in accordance with an embodiment of the present disclosure. The diagram 500 includes a block diagram of an example circuit design 510 that may be implemented using the design software 114. The circuit design 510 includes a number of components, such as a processor core 511, memory 513, a universal asynchronous receiver-transmitter (UART) 515, a 32-bit interval timer 517, and a 64-bit interval timer 519. Components of the circuit design 510 may be implemented using vendor IP blocks obtained from a design tool library of vendor IP blocks (e.g., the design tool library 120) or customer IP blocks (e.g., the customer IP blocks 132). The design software 114 may send configuration data (e.g., the configuration data 128) corresponding to the circuit design 510 to both the PLD builder 138 and the VP builder 144 for further processing.

The diagram 500 also includes an RTL hierarchy 520 of RTL logic that the PLD builder 138 may generate based on the configuration data that corresponds to the circuit design 510. The RTL hierarchy 520 may include an instance of RTL logic for each component of the circuit design 510, such as processor RTL logic 521 for the processor core 511, memory RTL logic 523 for the memory 513, UART RTL logic 525 for the UART 515, first timer RTL logic 527 for the 32-bit interval timer 517, and second timer RTL logic 529 for the 64-bit interval timer 519. The diagram 500 shows that instances of RTL logic in the RTL hierarchy 520 may be nested hierarchically to conform with the circuit design 510.

The diagram 500 also includes a chip-level model hierarchy 530 of simulation objects that the VP builder 144 may generate based on the configuration data that corresponds to the circuit design 510. The chip-level model hierarchy 530 may include a simulation object for each component of the circuit design 510, such as a processor object 531 for the processor core 511, a memory object 533 for the memory 513, a UART object 535 for the UART 515, a first timer object 537 for the 32-bit interval timer 517, and a second timer object 529 for the 64-bit interval timer 519. Each simulation object of the chip-level model hierarchy 530 may have a corresponding instance of RTL logic in the RTL hierarchy 520. For example, the processor object 531 may correspond to the processor RTL logic 521, the memory object 533 may correspond to the memory RTL logic 523, the UART object 535 may correspond to the UART RTL logic 525, the first timer object 537 may correspond to the first timer RTL logic 527, and the second timer object 539 may correspond to the second timer RTL logic 529. The diagram 500 also shows that simulation objects in the chip-level model hierarchy 530 may be nested hierarchically to conform with the RTL hierarchy 520. A one-to-one mapping may be maintained between simulation objects of the chip-level model hierarchy 530 and components (e.g., customer IP blocks and/or vendor IP blocks) of the circuit design 510 by conforming the chip-level model hierarchy 530 with the RTL hierarchy 520.

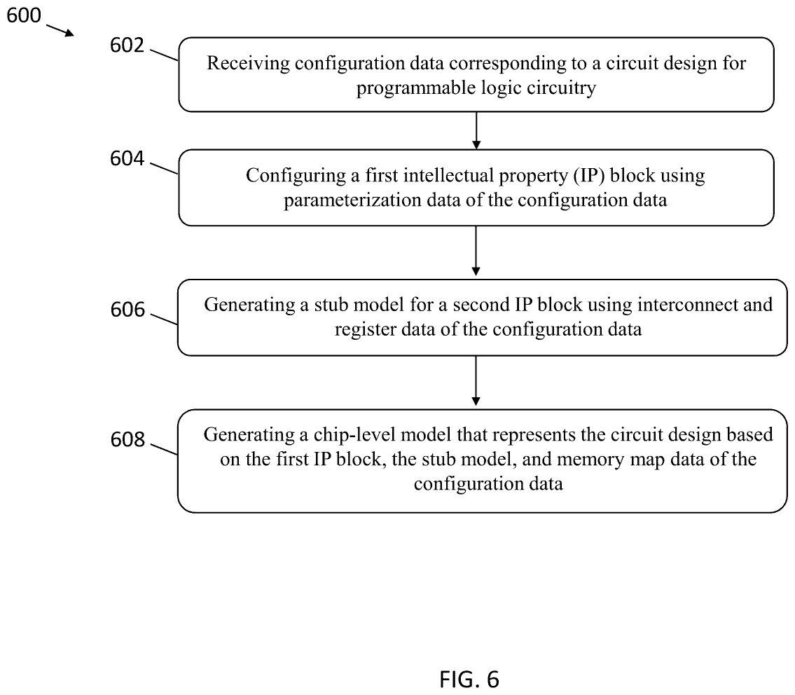

With the foregoing in mind, FIG. 6 is a flow diagram of a process 600 for generating virtual platform models of integrated circuit designs, in accordance with an embodiment of the present disclosure. The VP builder 144, at process block 602, may receive configuration data (e.g., the configuration data 128). The VP builder 144, at process block 604, may configure a first IP block (e.g., the vendor IP block 122) using parameterization data (e.g., parameterization data of the design constraints 136) of the configuration data. The VP builder 144, at process block 606, may generate a stub model (e.g., the stub model 150) for a second IP block (e.g., the customer IP block 130) using interconnect and register data (e.g., the interconnect and register data 134) of the configuration data. In an embodiment, generating the stub model by the VP builder 144 may include generating a wrapper that includes implementation code that characterizes parameters of the second IP block. In an embodiment, the first IP block may be available in a design tool library of vendor IP blocks (e.g., the design tool library 120) and the second IP block may be unavailable in the design tool library.

The VP builder 144, at process block 608, may generate a chip-level model (e.g., the chip-level model 152) that represents the circuit design based on the first IP block, the stub model, and memory map data (e.g., memory map data of the design constraints 136) of the configuration data. The chip-level model generated by the VP builder 144 may be consumable by a virtual platform simulator. In an embodiment, the chip-level model may instantiate a chip-level memory map that characterizes connectivity between the first IP block and the stub model. In an embodiment, the VP builder 144 may provide the chip-level model to the virtual platform simulator. In an embodiment, the chip-level model may be configured to execute a software binary (e.g., the software binary 175) that is executable by an implementation of the circuit design on the programmable logic circuitry. In an embodiment, the VP builder 144 may generate a platform-level model (e.g., the virtual platform 156) based on the chip-level model and external connectivity data (e.g., external connectivity data of the design constraints 136).

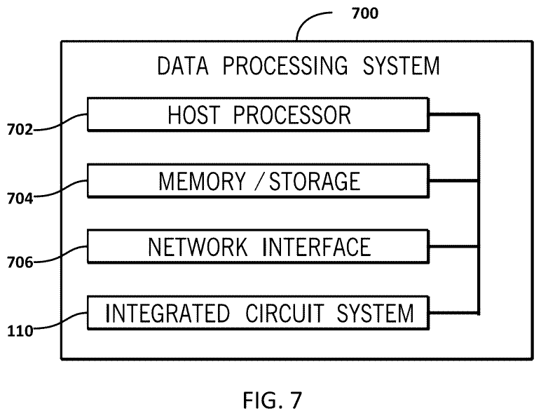

With the foregoing in mind, the integrated circuit system 110 may be a component included in a data processing system, such as a data processing system 700, shown in FIG. 7. The data processing system 700 may include the integrated circuit system 110 (e.g., a programmable logic device), a host processor 702, memory and/or storage circuitry 704, and a network interface 706. The data processing system 700 may include more or fewer components (e.g., electronic display, designer interface structures, ASICs). Moreover, any of the circuit components depicted in FIG. 7 may include integrated circuits (e.g., integrated circuit system 110). The host processor 702 may include any of the foregoing processors that may manage a data processing request for the data processing system 700 (e.g., to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 704 may include random access memory (RAM), read-only memory (ROM), one or more hard drives, flash memory, or the like. The memory and/or storage circuitry 704 may hold data to be processed by the data processing system 700. In certain embodiments, the memory and/or storage circuitry 704 may store instructions, that when executed by the host processor 702, causes the host processor 702 to perform any of the operations discussed herein. In some cases, the memory and/or storage circuitry 704 may also store configuration programs (bit streams) for programming the integrated circuit system 110. The network interface 706 may allow the data processing system 700 to communicate with other electronic devices. The data processing system 700 may include several different packages or may be contained within a single package on a single package substrate. For example, components of the data processing system 700 may be located on several different packages at one location (e.g., a data center) or multiple locations. For instance, components of the data processing system 700 may be located in separate geographic locations or areas, such as cities, states, or countries.

In one example, the data processing system 700 may be part of a data center that processes a variety of different requests. For instance, the data processing system 700 may receive a data processing request via the network interface 706 to perform encryption, decryption, machine learning, video processing, voice recognition, image recognition, data compression, database search ranking, bioinformatics, network security pattern identification, spatial navigation, digital signal processing, or some other specialized task.

The above discussion has been provided by way of example. Indeed, the embodiments of this disclosure may be susceptible to a variety of modifications and alternative forms. While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible, or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

### EXAMPLE EMBODIMENTS

### Example Embodiment 1

A method may include receiving configuration data corresponding to a circuit design for programmable logic circuitry, configuring a first intellectual property (IP) block using parameterization data of the configuration data, generating a stub model for a second IP block using interconnect and register data of the configuration data, and generating a chip-level model that represents the circuit design based on the first IP block, the stub model, and memory map data of the configuration data, where the chip-level model is consumable by a virtual platform simulator.

### Example Embodiment 2

The method of example embodiment 1 may also include generating a platform-level model based on the chip-level model and external connectivity data of the configuration data.

### Example Embodiment 3

The method of example embodiment 1 may also include comprising providing the chip-level model to the virtual platform simulator.

### Example Embodiment 4

The method of example embodiment 1 may also generating the stub model comprises generating a wrapper that includes implementation code that characterizes parameters of the second IP block.

### Example Embodiment 5

The method of example embodiment 1, where the chip-level model instantiates a chip-level memory map that characterizes connectivity between the first IP block and the stub model.

### Example Embodiment 6

The method of example embodiment 1, where the chip-level model is configured to execute a software binary that is executable by an implementation of the circuit design on the programmable logic circuitry.

### Example Embodiment 7

The method of example embodiment 1, where the first IP block is available in a design tool library of vendor IP blocks, and the second IP block is unavailable in the design tool library.

### Example Embodiment 8

The method of example embodiment 1, where a hierarchy of the chip-level model conforms to a hierarchy of a register-transfer level (RTL) model characterizing the circuit design.

### Example Embodiment 9

A tangible, non-transitory, computer-readable medium, may include instructions that, when executed by a processor, cause operations to be performed that include receiving configuration data corresponding to a circuit design for programmable logic circuitry, generating a stub model for an intellectual property (IP) block using interconnect and register data of the configuration data, generating a chip-level model that represents the circuit design based on the stub model, and memory map data of the configuration data, and executing a software binary that is executable by an implementation of the circuit design on the programmable logic circuitry using the chip-level model.

### Example Embodiment 10

The tangible, non-transitory, computer-readable medium of example embodiment 9, where the software binary comprises a bootloader, an operating system, low-level firmware, middleware, a library, software development kit, an application programming interface, or a combination thereof.

### Example Embodiment 11

The tangible, non-transitory, computer-readable medium of example embodiment 9, where the operations also include generating a platform-level model based on the chip-level model and external connectivity data of the configuration data.

### Example Embodiment 12

The tangible, non-transitory, computer-readable medium of example embodiment 11, where the external connectivity data comprises input/output (I/O) pin assignments of a board-level component.

### Example Embodiment 13

The tangible, non-transitory, computer-readable medium of example embodiment 9, where the memory map data includes information for integrating the implementation of the circuit design on the programmable logic circuitry with a board-level component.

### Example Embodiment 14

The tangible, non-transitory, computer-readable medium of example embodiment 9, where the memory map data defines an association between a register map of the stub model and another register map.

### Example Embodiment 15

An electronic device may include a processor and memory coupled to the processor, where the memory stores instructions which, when executed by the processor, cause the processor to receive configuration data corresponding to a circuit design for programmable logic circuitry, generate a bitstream based on the configuration data, generate a stub model for an intellectual property (IP) block using interconnect and register data of the configuration data, and output the bitstream to the programmable logic circuitry and the stub model to a simulator application.

### Example Embodiment 16

The electronic device of example embodiment 15, where the memory store instructions which, when executed by the processor, cause the processor to generate a platform-level model based on the stub model and external connectivity data of the configuration data.

### Example Embodiment 17

The electronic device of example embodiment 15, the memory storing instructions which, when executed by the processor, cause the processor to execute a software binary that is executable by an implementation of the circuit design on the programmable logic circuitry.

### Example Embodiment 18

The electronic device of example embodiment 15, wherein the memory map data defines an association between a register map of the stub model and a system-level map.

### Example Embodiment 19

The electronic device of example embodiment 15, wherein the IP block is unavailable in a design tool library of vendor IP blocks.

### Example Embodiment 20

The electronic device of example embodiment 19, the memory storing instructions which, when executed by the processor, cause the processor to receive a vendor IP block from the design tool library, and configure the vendor IP block using parameterization data of the configuration data.

What is claimed is:

1. A method comprising:
receiving configuration data corresponding to a circuit design for programmable logic circuitry;
configuring a first intellectual property (IP) block using parameterization data of the configuration data;
generating a stub model for a second IP block using interconnect and register data of the configuration data; and
generating a chip-level model that represents the circuit design based on the first IP block, the stub model, and memory map data of the configuration data, wherein the chip-level model is consumable by a virtual platform simulator.

2. The method of claim 1, comprising generating a platform-level model based on the chip-level model and external connectivity data of the configuration data.

3. The method of claim 1, comprising providing the chip-level model to the virtual platform simulator.

4. The method of claim 1, wherein generating the stub model comprises generating a wrapper that includes implementation code that characterizes parameters of the second IP block.

5. The method of claim 1, wherein the chip-level model instantiates a chip-level memory map that characterizes connectivity between the first IP block and the stub model.

6. The method of claim 1, wherein the chip-level model is configured to execute a software binary that is executable by an implementation of the circuit design on the programmable logic circuitry.

7. The method of claim 1, wherein the first IP block is available in a design tool library of vendor IP blocks, and the second IP block is unavailable in the design tool library.

8. The method of claim 1, wherein a hierarchy of the chip-level model conforms to a hierarchy of a register-transfer level (RTL) model characterizing the circuit design.

9. A tangible, non-transitory, computer-readable medium, comprising instructions that, when executed by a processor, cause operations to be performed comprising:
receiving configuration data corresponding to a circuit design for programmable logic circuitry;
generating a stub model for an intellectual property (IP) block using interconnect and register data of the configuration data;
generating a chip-level model that represents the circuit design based on the stub model, and memory map data of the configuration data; and
executing a software binary that is executable by an implementation of the circuit design on the programmable logic circuitry using the chip-level model.

10. The tangible, non-transitory, computer-readable medium of claim 9, wherein the software binary comprises a bootloader, an operating system, low-level firmware, middleware, a library, software development kit, an application programming interface, or a combination thereof.

11. The tangible, non-transitory, computer-readable medium of claim 9, the operations comprising generating a platform-level model based on the chip-level model and external connectivity data of the configuration data.

12. The tangible, non-transitory, computer-readable medium of claim 11, wherein the external connectivity data comprises input/output (I/O) pin assignments of a board-level component.

13. The tangible, non-transitory, computer-readable medium of claim 9, wherein the memory map data includes information for integrating the implementation of the circuit design on the programmable logic circuitry with a board-level component.

14. The tangible, non-transitory, computer-readable medium of claim 9, wherein the memory map data defines an association between a register map of the stub model and another register map.

15. An electronic device comprising:
a processor; and
memory coupled to the processor, the memory storing instructions which, when executed by the processor, cause the processor to:
receive configuration data corresponding to a circuit design for programmable logic circuitry;
generate a bitstream based on the configuration data;
generate a stub model for an intellectual property (IP) block using interconnect and register data of the configuration data; and
output the bitstream to the programmable logic circuitry and the stub model to a simulator application.

16. The electronic device of claim 15, the memory storing instructions which, when executed by the processor, cause the processor to:
generate a platform-level model based on the stub model and external connectivity data of the configuration data.

17. The electronic device of claim 15, the memory storing instructions which, when executed by the processor, cause the processor to:
execute a software binary that is executable by an implementation of the circuit design on the programmable logic circuitry.

18. The electronic device of claim 15, wherein the memory map data defines an association between a register map of the stub model and a system-level map.

19. The electronic device of claim 15, wherein the IP block is unavailable in a design tool library of vendor IP blocks.

20. The electronic device of claim 19, the memory storing instructions which, when executed by the processor, cause the processor to:
receive a vendor IP block from the design tool library; and
configure the vendor IP block using parameterization data of the configuration data.
